(19) United States
(12) Patent Application Publication
(10) Pub. No.: US 2021/0364098 A1
(43) Pub. Date: Nov. 25, 2021

(54) FLUID MIXING VALVE BODY ASSEMBLY

(71) Applicant: NCIP INC., Taipei (TW)

(72) Inventor: RONG-CHYAN TZENG, TAIPEI (TW)

(21) Appl. No.: 16/879,331

(22) Filed: May 20, 2020

(51) Int. Cl. F16K 27/04; F16K 11/078

(52) U.S. Cl. CPC F16K 27/045; F16K 17/18; F16K 11/0782

(57) ABSTRACT

A fluid mixing valve body assembly comprises a base including two first water inlet holes, a first water outlet hole and a plurality of positioning holes; a first valve body including two second water inlet holes and a second water outlet hole; and an adapter disposed between the base and the first valve body. A mismatch is formed between the first and second water inlet holes correspondingly or between the first and second water outlet holes. The adapter including a first side and a second side, the first side including two first water inlet openings and a first water outlet opening respectively connected to the two first water inlet holes and the first water outlet hole, and the second side including two second water inlet openings and a second water outlet opening respectively connected to the two second water inlet holes and the second water outlet hole.

### FIELD OF THE INVENTION

The present invention relates to a valve body assembly, and more particularly to a fluid mixing valve body assembly with an adapter.

### BACKGROUND OF THE INVENTION

In order to make the bathroom decoration simple and aesthetic, most of the shower equipment currently used in the market are wall-embedded. The entire water plumbing of the shower equipment is embedded in the wall, and only the shower head and the water outlet switch are exposed, thereby not only saving the space occupied by the shower equipment, but also enhancing the aesthetic of the bathroom. In order to maintain the same water temperature during shower, a valve body for adjusting the mixing ratio of hot and cold water is installed at the water inlet end connecting the shower head to provide a preset water temperature.

Generally speaking, a thermostatic valve body or a pressure balance valve body can be selected according to different needs. Among them, the thermostatic valve body uses the displacement or expansion of the temperature-sensing probe installed at the water outlet to adjust the inflows of hot water and cold water, so that the final mixing temperature of cold and hot water is kept constant. As disclosed in U.S. Patent Publication No. US 2011/0146812 A1, a thermostatic valve control structure uses a temperature-sensing rod and a regulating member to control opening sizes of a hot water inlet and a cold water inlet. In another example, U.S. Pat. No. 7,850,088 B2 discloses a thermostatic water mixing valve, which adjusts opening sizes of a hot water inlet and a cold water inlet by a rotatable upper cover to mix out constant temperature water at different temperatures.

Furthermore, the pressure balance valve body uses a diaphragm or a piston to compensate for a relative change between the hot water pressure and cold water pressure to maintain the pressure balance of the hot and cold and stabilize the water temperature. As disclosed in U.S. Patent Publication No. US 2013/0199632 and Chinese Patent No. CN 205639697U, a pressure balance valve includes a motion valve or a pressure regulating member. It provided between a cold water inlet and a hot water inlet to control inflows of hot water and cold water to achieve the efficacy of mixing water with different temperatures.

However, each valve body has a different installation structure to be assembled and fixed with a specific base, that is, the same base cannot be used between different valve bodies. Once the user wants to replace with different valve bodies, the entire set of faucet components including the base and the valve body needs to be removed and replaced, resulting in increased refitting costs, manpower, and construction time.

### SUMMARY OF THE INVENTION

An object of the present invention is to solve the problem of increasing the costs and installation time caused by replacing the faucet together with the conventional valve replacement.

In order to achieve the above object, the present invention provides a fluid mixing valve body assembly comprising a base, a first valve body and an adapter. The base includes a cold water pipe, a hot water pipe, a water outlet pipe, and a valve chamber communicating with the cold water pipe, the hot water pipe and the water outlet pipe. The valve chamber extends into a cylindrical shape along an axial direction and includes an opening and a lateral portion. The lateral portion includes two first water inlet holes respectively connected to the cold water pipe and the hot water pipe, one first water outlet hole connected to the water outlet pipe, and a plurality of positioning holes. The first valve body is installed at the opening of the valve chamber and assembled with the base. The first valve body includes a first valve core, a first valve rod extending from the first valve core in a direction away from the base, and a first valve seat disposed on one end of the first valve core close to the base. The first valve seat includes two second water inlet holes and a second water outlet hole, wherein a mismatch is formed between one of the first water inlet holes and the corresponding second water inlet hole or between the first water outlet hole and the second water outlet hole. The adapter is disposed between the base and the first valve body and located in the valve chamber. The adapter includes a body, a first side adjacent to the base, and a second side adjacent to the first valve body. The first side includes two first water inlet openings respectively communicating with the two first water inlet holes, and a first water outlet opening communicating with the first water outlet hole. The second side includes two second water inlet openings respectively communicating with the two second water inlet holes, and a second water outlet opening communicating with the second water outlet hole. A water inlet passage penetrates the body and is formed between one of the first water inlet openings and the corresponding second water inlet opening, and a water outlet passage penetrates the body and is formed between the first water outlet opening and the second water outlet opening.

In one embodiment of the present invention, there is a longitudinal drop between the first water outlet hole and the second water outlet hole.

In one embodiment of the present invention, there is a transverse drop between the first water outlet hole and the second water outlet hole.

In one embodiment of the present invention, there is an outer diameter difference between the first water outlet hole and the second water outlet hole.

In one embodiment of the present invention, the first water outlet hole and the second water outlet hole are disposed non-coaxially.

In one embodiment of the present invention, the adapter includes a barrier wall disposed on the first side and surrounding the two first water inlet openings, and the barrier wall separates the two first water inlet openings and forms two recesses.

In one embodiment of the present invention, the base includes a water outlet connecting pipe and two water inlet connecting pipes. The water outlet connecting pipe is connected between the first water outlet hole and the water outlet pipe. One of the two water inlet connecting pipes is connected with one of the first water inlet holes and the cold water pipe; and the other of the two water inlet connecting pipes is connected with the other of the first water inlet holes and the hot water pipe. The water inlet connecting pipe has a bent structure.

Accordingly, through the adapter with the two sides respectively corresponding to the base and the first valve body, the fluid mixing valve body assembly of the present invention makes the base and the first valve body with the mismatch to communicate with each other. Compared with the conventional valve body, the base can only be used for a single type of valve body, the present invention is capable of achieving a general-purpose efficacy through the disposition of the adapter to assemble with different valve bodies without replacing the base, thereby saving refitting costs, manpower and construction time required for replacing with different valve bodies.

### BRIEF DESCRIPTION OF THE DRAWINGS

FIG. 1 is a perspective assembly view of one embodiment of the present invention;

FIG. 2A is an exploded perspective view of one embodiment of the present invention;

FIG. 2B is an exploded perspective view of one embodiment of the present invention viewed from another viewing angle;

FIG. 3 is a front view of an adapter of the present invention;

FIG. 4 is a back view of the adapter of the present invention;

FIG. 5A is an exploded perspective view of one embodiment of the present invention;

FIG. 5B is an exploded perspective view of one embodiment of the present invention viewed from another viewing angle;

FIG. 6 is a cross-sectional view of a base of the present invention taken along section line A-A′ of FIG. 2B; and

FIG. 7 is a cross-sectional view of a base of the present invention taken along section line B-B′ of FIG. 2B.

### DETAILED DESCRIPTION OF THE PREFERRED EMBODIMENTS

The detailed description and technical contents of the present invention are described below with reference to the drawings.

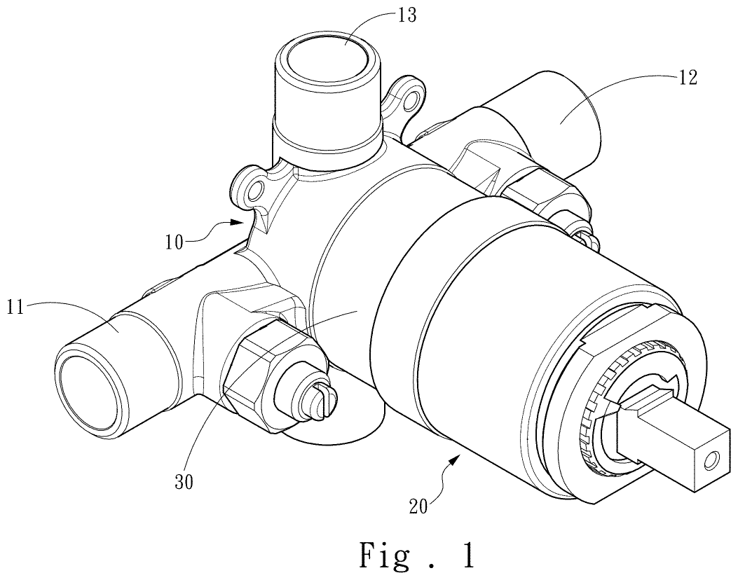

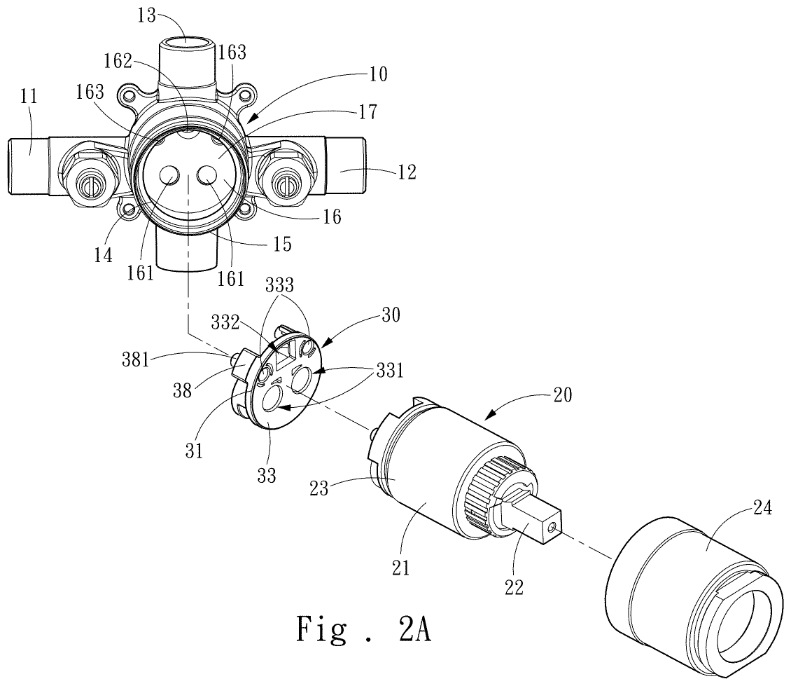

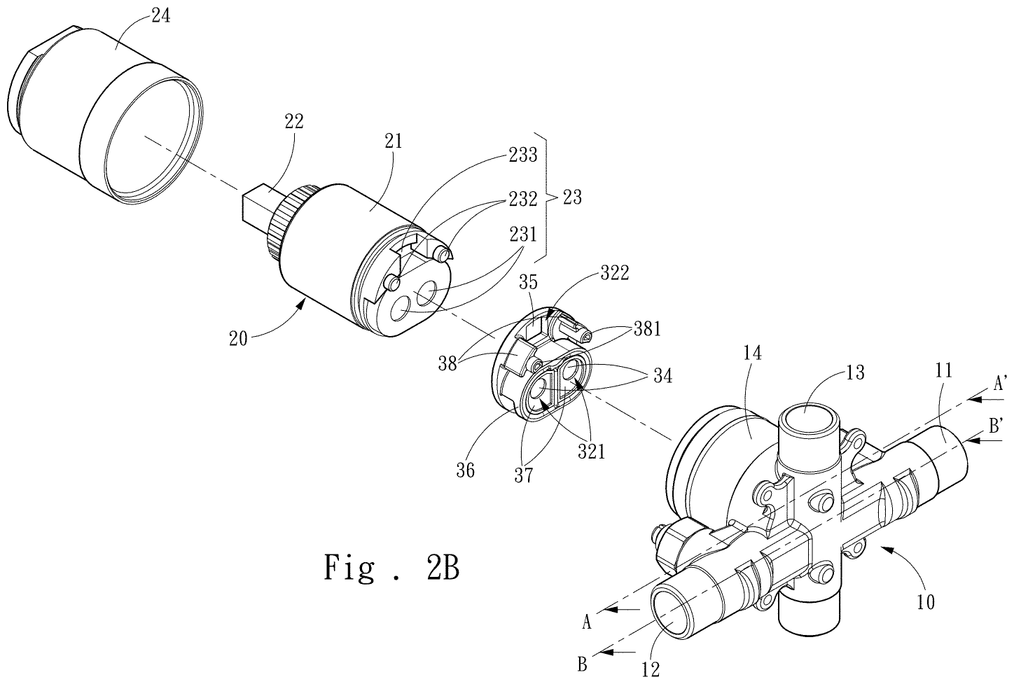

Please refer to FIG. 1, FIG. 2A, and FIG. 2B for perspective assembly view and exploded perspective views of one embodiment of a fluid mixing valve body assembly of the present invention. In one embodiment, the fluid mixing valve body assembly of the present invention includes a base 10, a first valve body 20 and an adapter 30. The base 10 includes a cold water pipe 11, a hot water pipe 12, a water outlet pipe 13 and a valve chamber 14. The valve chamber 14 communicates with the cold water pipe 11, the hot water pipe 12 and the water outlet pipe 13.

The cold water pipe 11 and the hot water pipe 12 are connected to an external water supply system to import cold water and hot water into the valve chamber 14 respectively, and the water outlet pipe 13 is connected to a shower head (not shown in the figures) to export water in the valve chamber 14 to the shower head for a user to use. The cold water pipe 11, the hot water pipe 12 and the water outlet pipe 13 are disposed on a same plane, and the valve chamber 14 extends into a cylindrical shape along an axial direction perpendicular to the plane where the cold water pipe 11, the hot water pipe 12 and the water outlet pipe 13 are disposed on. Two ends of the valve chamber 14 include an opening 15 and a lateral portion 16 separately. The lateral portion 16 includes two first water inlet holes 161 communicates with the cold water pipe 11 and the hot water pipe 12 respectively, a first water outlet hole 162 communicates with the water outlet pipe 13, and a plurality of positioning holes 163.

The first valve body 20 is installed at the opening 15 of the valve chamber 14 and assembled with the base 10. The first valve body 20 includes a first valve core 21, a first valve rod 22 extending from the first valve core 21 in a direction away from the base 10, and a first valve seat 23 disposed on one end of the first valve core 21 close to the base 10. The first valve seat 23 includes two second water inlet holes 231, two convex portions 232 and a second water outlet hole 233. When the first valve body 20 is assembled on the base 10, a mismatch is formed between the first water inlet holes 161 and the second water inlet holes 231 or between the first water outlet hole 162 and the second water outlet hole 233. The so-called “mismatch” refers to the inconsistency between corresponding positions or contour appearances between the two holes, so that the base 10 and the first valve body 20 cannot directly communicate with each other. In one embodiment, there is a longitudinal drop or a transverse drop between the first water outlet hole 162 and the second water outlet hole 233, or the first water outlet hole 162 and the second water outlet hole 233 are disposed non-coaxially, so that positions of the first water outlet hole 162 and the second water outlet hole 233 after assembly cannot correspond to each other. In another embodiment, there is an outer diameter difference between the first water outlet hole 162 and the second water outlet hole 233.

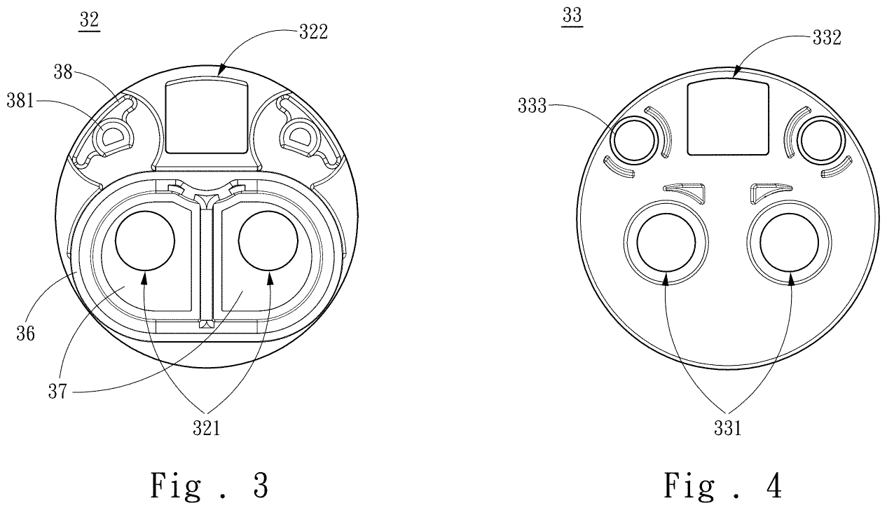

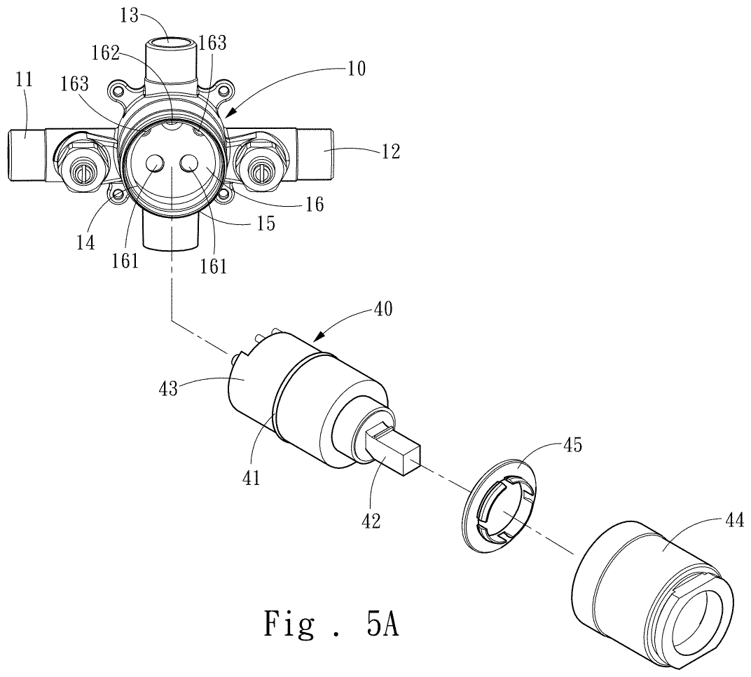

The adapter 30 is provided between the base 10 and the first valve body 20, and the adapter 30 includes a body 31, a first side 32 adjacent to the base 10, and a second side 33 adjacent to the first valve body 20. Please refer to FIG. 3 and FIG. 4, which are front view and back view of the adapter 30 respectively, together with FIG. 1, FIG. 2A, and FIG. 2B. The first side 32 of the adapter 30 includes two first water inlet openings 321 respectively connected to the two first water inlet holes 161, and a first water outlet opening 322 connected to the first water outlet hole 162. The second side 33 includes two second water inlet openings 331 respectively connected to the two second water inlet holes 231, a second water outlet opening 332 connected to the second water outlet hole 233, and two assembling holes 333. A water inlet passage 34 penetrating the body 31 is formed between each of the first water inlet openings 321 and one of the second water inlet openings 331, and a water outlet passage 35 penetrating the body 31 is formed between the first water outlet opening 322 and the second water outlet opening 332. The assembling holes 333 are correspondingly connected with the convex portions 232.

Further, the adapter 30 includes a barrier wall 36 disposed on the first side 32 and surrounding the two first water inlet openings 321. The barrier wall 36 separates the two first water inlet openings 321 and forms two recesses 37. The adapter 30 further includes a plurality of assembly members 38 on the first side 32. The barrier wall 36 has a thickness, which is equivalent to a distance between the first valve body 20 and the base 10 when the first valve body 20 is assembled to the base 10 via the adapter 30. Thereby the barrier wall 36 can avoid the water out of the base 10 flowing out from a gap between the base 10 and the first valve body 20. Each of the assembly members 38 includes a protruding portion 381, and the protruding portions 381 are correspondingly assembled to the positioning holes 163.

In one embodiment, the first valve body 20 includes a first valve housing 24 sleeved on the first valve core 21. One end of the first valve housing 24 is provided for the first valve rod 22 to pass through, and the other end of the first valve housing 24 is assembled with the base 10. In one embodiment, the first valve body 20 is a pressure balance valve, and its structure and principle belong to the common techniques in the art, and will not be repeated here.

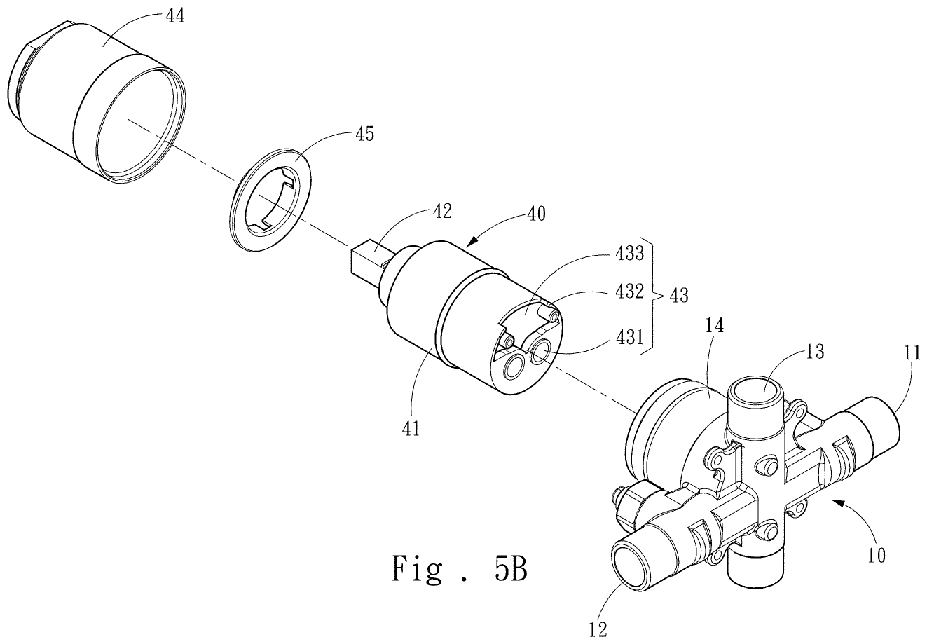

The following describes a specific implementation manner of one embodiment of the present invention. During assembly, the two first water inlet openings 321 and the first water outlet opening 322 on the first side 32 of the adapter 30 respectively correspond to the two first water inlet holes 161 and the first water outlet hole 162 on the base 10; and the two second water inlet openings 331 and the second water outlet opening 332 on the second side 33 respectively correspond to the two second water inlet holes 231 and the second water outlet hole 233 on the first valve seat 23. Thereby, the base 10 and the first valve body 20 communicate with each other via the adapter 30. In detail, cold water and hot water from the cold water pipe 11 and the hot water pipe 12 flow into the valve chamber 14 through the two first water inlet holes 161 respectively, then pass through the body 31 of the adapter 30 from flowing into the two first water inlet openings 321 and out of the two second water inlet openings 331, and then flow into the two second water inlet holes 231 of the first valve seat 23. A ratio of cold water and hot water is adjusted by the first valve body 20, and a warm water at an appropriate temperature is mixed. The warm water flows from the second water outlet hole 233 of the first valve seat 23 into the second water outlet opening 332 of the adapter 30, and passes through the body 31. And the warm water flows out from the first water outlet opening 322, and then flows into the first water outlet hole 162 of the base 10, and finally the warm water is output from the water outlet pipe 13 to the shower head for the user to use. Please refer to FIG. 5A and FIG. 5B for exploded perspective views of another embodiment of the present invention. The fluid mixing valve body assembly of the present invention includes a base 10 and a second valve body 40. The difference between this embodiment and the previous embodiment is that the second valve body 40 is directly installed on the base 10 without providing an adapter therebetween. The fluid mixing valve body assembly further provides the second valve body 40 which can be selectively replaced by a first valve body 20 and an adapter 30 (as shown in FIG. 1), so that the user is able to install the first valve body 20 or the second valve body 40 on the same base 10 according to different requirements. Besides, the structures of the base 10, the first valve body 20 and the adapter 30 are the same as the previous embodiment, which is not repeated here.

The second valve body 40 includes a second valve core 41, a second valve rod 42 extending from one end of the second valve core 41, and a second valve seat 43 disposed on the other end of the second valve core 41. The second valve seat 43 includes two third water inlet holes 431 respectively communicates with the two first water inlet holes 161 of the base 10, a third water outlet hole 433 communicates with the first water outlet hole 162, and a plurality of protrusions 432 disposed corresponding to the plurality of positioning holes 163 of the base 10. The plurality of protrusions 432 are inserted into the plurality of positioning holes 163 respectively to fix the second valve body 40 in the valve chamber 14 of the base 10. Further, the second valve body 40 includes a second valve housing 44 and a gasket 45 disposed between the second valve housing 44 and the second valve core 41. The second valve housing 44 is sleeved on the second valve core 41, wherein one end of the second valve housing 44 is provided for the second valve rod 42 to pass through, and the other end of the second valve housing 44 is assembled with the base 10. In one embodiment, the second valve body 40 is a thermostatic valve, and its structure and principle belong to the common techniques in the art, and will not be repeated here.

The following describes a specific implementation manner of the second embodiment of the present invention. When the second valve body 40 is assembled, since the two third water inlet holes 431 of the second valve body 40 are communicates with the two first water inlet holes 161 of the base 10, and the third water outlet hole 433 is communicates with the first water outlet hole 162, that is, the base 10 is capable of directly communicating with the second valve body 40 without the adapter 30. After cold water and hot water flow from the cold water pipe 11 and the hot water pipe 12 of the base 10, the cold water and hot water flow through the two first water inlet holes 161 on the lateral portion 16 respectively, and then flow into the two third water inlet holes 431 of the second valve seat 43. After the second valve body 40 adjusts inflows of the cold water and hot water and mixes the cold water and hot water into a warm water with a preset temperature, the warm water flows out from the third water outlet hole 433 of the second valve body 40, and flows to the base 10 and then flows out from the first water outlet hole 162 to the water outlet pipe 13, then to the shower head for the user to use.

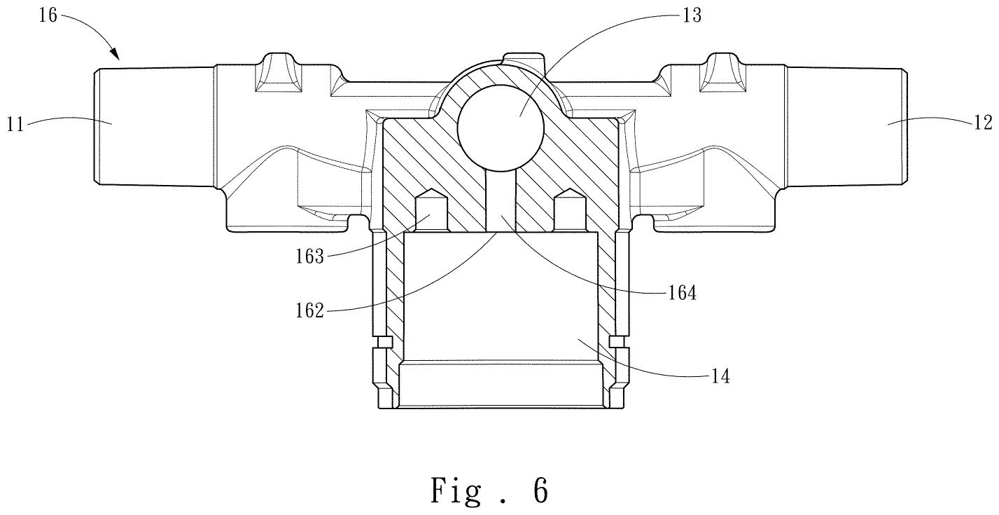

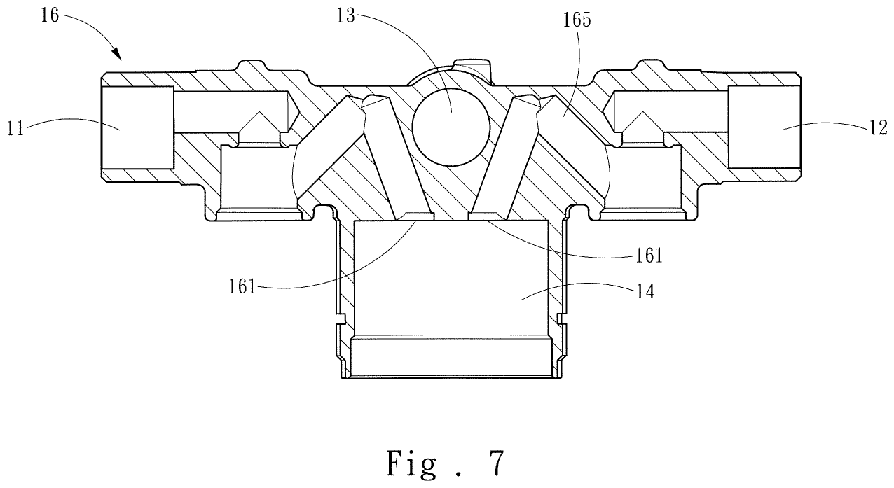

Besides, please refer to FIG. 6 and FIG. 7 for cross-sectional views of the base 10 of the present invention taken along section lines A-A′ and B-B′ of FIG. 2B respectively. FIG. 6 shows a cross-sectional view of the first water outlet hole 162 and the positioning holes 163 on an upper half of the lateral portion 16. In one embodiment, a quantity of the positioning holes 163 is two, and the positioning holes 163 are respectively provided on left and right sides of the first water outlet hole 162. A water outlet connecting pipe 164 is extended from the first water outlet hole 162 toward a direction of the water outlet pipe 13, and the water outlet connecting pipe 164 communicates with the water outlet pipe 13. FIG. 7 shows a cross-sectional view of the two first water inlet holes 161 of a lower half of the lateral portion 16. In one embodiment, the two first water inlet holes 161 are respectively connected to the cold water pipe 11 and the hot water pipe 12, a water inlet connecting pipe 165 is a bent structure and disposed between one of the two first water inlet holes 161 and either the cold water pipe 11 or the hot water pipe 12 respectively. Each of the water inlet connecting pipes 165 communicates with one of the first water inlet holes 161.

In summary, the present invention provides the adapter between the base and the first valve body, and the adapter includes the first side and the second side to correspond to the structures of the base and the first valve body respectively. Accordingly, even though the mismatch is formed between the first water inlet holes and the second water inlet holes or between the first water outlet hole and the second water outlet hole, the base and the first valve body are capable of communicating with each other through the adapter, so that the user can directly install and use the valve body different from the structure of the base without replacing the existing base, thereby reducing refitting costs, manpower, and construction time.

1. A fluid mixing valve body assembly for a shower head, including:
a base, including a cold water pipe, a hot water pipe, a water outlet pipe, and a valve chamber communicating with the cold water pipe, the hot water pipe and the water outlet pipe, the valve chamber extending into a cylindrical shape along an axial direction and including an opening and a lateral portion, the lateral portion including two first water inlet holes respectively connected to the cold water pipe and the hot water pipe, one first water outlet hole connected to the water outlet pipe, and a plurality of positioning holes;
a first valve body, installed at the opening of the valve chamber and assembled with the base, the first valve body including a first valve core, a first valve rod extending from the first valve core in a direction away from the base, and a first valve seat disposed on one end of the first valve core close to the base, the first valve seat including two second water inlet holes and a second water outlet hole, wherein a mismatch is formed between one of the first water inlet holes and the corresponding second water inlet hole or between the first water outlet hole and the second water outlet hole, a longitudinal drop or a transverse drop is formed between the first water outlet hole and the second water outlet hole, and the first valve body do not communicate with the base; and
an adapter, disposed between the base and the first valve body and located in the valve chamber, the adapter including a body, a first side adjacent to the base, and a second side adjacent to the first valve body, the first side including two first water inlet openings respectively communicating with the two first water inlet holes, and a first water outlet opening communicating with the first water outlet hole, the second side including two second water inlet openings respectively communicating with the two second water inlet holes, and a second water outlet opening communicating with the second water outlet hole, a water inlet passage penetrating the body and formed between one of the first water inlet openings and the corresponding second water inlet opening, and a water outlet passage penetrating the body and formed between the first water outlet opening and the second water outlet opening.

2. (canceled)

3. (canceled)

4. The fluid mixing valve body assembly as claimed in claim 1, wherein there is an outer diameter difference between the first water outlet hole and the second water outlet hole.

5. The fluid mixing valve body assembly as claimed in claim 1, wherein the first water outlet hole and the second water outlet hole are disposed non-coaxially.

6. The fluid mixing valve body assembly as claimed in claim 1, wherein the first valve body is a pressure balance valve.

7. The fluid mixing valve body assembly as claimed in claim 1, wherein the adapter includes a barrier wall disposed on the first side and surrounding the two first water inlet openings, and the barrier wall separates the two first water inlet openings and forms two recesses.

8. The fluid mixing valve body assembly as claimed in claim 1, wherein the base includes a water outlet connecting pipe and two water inlet connecting pipes, the water outlet connecting pipe is connected between the first water outlet hole and the water outlet pipe, one of the two water inlet connecting pipes is connected with one of the first water inlet holes and the cold water pipe, the other of the two water inlet connecting pipes is connected with the other of the first water inlet holes and the hot water pipe, and each water inlet connecting pipe is a bent structure.

9. A fluid mixing valve body assembly for a shower head, including:
a base, including a cold water pipe, a hot water pipe, a water outlet pipe, and a valve chamber communicating with the cold water pipe, the hot water pipe and the water outlet pipe, the valve chamber extending into a cylindrical shape along an axial direction and including an opening and a lateral portion, the lateral portion including two first water inlet holes respectively connected to the cold water pipe and the hot water pipe, one first water outlet hole connected to the water outlet pipe, and a plurality of positioning holes; and
a second valve body, including a second valve core, a second valve rod extending from one end of the second valve core, and a second valve seat disposed on the other end of the second valve core, the second valve seat including two third water inlet holes respectively communicating with the two first water inlet holes, a third water outlet hole communicating with the first water outlet hole, and a plurality of protrusions disposed corresponding to the plurality of positioning holes of the base, the protrusions inserted into the positioning holes respectively to fix the second valve body in the valve chamber of the base;
wherein the second valve body is selectively replaced with a first valve body and an adapter;
wherein the first valve body installed at the opening of the valve chamber and assembled with the base, the first valve body including a first valve core, a first valve rod extending from the first valve core in a direction away from the base, and a first valve seat disposed on one end of the first valve core close to the base, the first valve seat including two second water inlet holes and a second water outlet hole, wherein a mismatch is located between one of the first water inlet holes and the corresponding second water inlet hole or between the first water outlet hole and the second water outlet hole, a longitudinal drop or a transverse drop is formed between the first water outlet hole and the second water outlet hole, and the first valve body do not communicate with the base; and
wherein the adapter disposed between the base and the first valve body and located in the valve chamber, the adapter including a body, a first side adjacent to the base, and a second side adjacent to the first valve body, the first side including two first water inlet openings respectively communicating with the two first water inlet holes, and a first water outlet opening communicating with the first water outlet hole, the second side including two second water inlet openings respectively communicating with the two second water inlet holes, and a second water outlet opening communicating with the second water outlet hole, a water inlet passage penetrating the body and formed between one of the first water inlet openings and the corresponding second water inlet openings, and a water outlet passage penetrating the body and formed between the first water outlet opening and the second water outlet opening.

10. (canceled)

11. (canceled)

12. The fluid mixing valve body assembly as claimed in claim 9, wherein there is an outer diameter difference between the first water outlet hole and the second water outlet hole.

13. The fluid mixing valve body assembly as claimed in claim 9, wherein the first water outlet hole and the second water outlet hole are disposed non-coaxially.

14. The fluid mixing valve body assembly as claimed in claim 9, wherein the first valve body is a pressure balance valve, and the second valve body is a thermostatic valve.

15. The fluid mixing valve body assembly as claimed in claim 9, wherein the adapter includes a barrier wall disposed on the first side and surrounding the two first water inlet openings, and the barrier wall separates the two first water inlet openings and forms two recesses.

16. The fluid mixing valve body assembly as claimed in claim 9, wherein the base includes a water outlet connecting pipe and two water inlet connecting pipes, the water outlet connecting pipe is connected between the first water outlet hole and the water outlet pipe, one of the two water inlet connecting pipes is connected with one of the first water inlet holes and the cold water pipe, the other of the two water inlet connecting pipes is connected with the other of the first water inlet holes and the hot water pipe, and each water inlet connecting pipe is a bent structure.
